(19) United States
(12) Patent Application Publication
(10) Pub. No.: US 2025/0116136 A1
(43) Pub. Date: Apr. 10, 2025

(54) RESTRAINT APPARATUS

(71) Applicant: Ricky A De La Peña, Elgin, IL (US)

(72) Inventor: Ricky A De La Peña, Elgin, IL (US)

(21) Appl. No.: 18/377,992

(22) Filed: Oct. 9, 2023

(51) Int. Cl. E05B 75/00; H05C 1/00

(52) U.S. Cl. CPC E05B 75/00; H05C 1/00

(57) ABSTRACT

A restraint apparatus for releasably restraining a body part of an individual via multiple attachment means includes a handcuff with a housing, a stationary strand, and a movable strand. The stationary strand and the movable strand are positionable to extend around the body part. The housing is removably couplable to a receiver, which may be coupled to another handcuff via a tether.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to restraint apparatuses and more particularly pertains to a new restraint apparatus for releasably restraining a body part of an individual via multiple attachment means.

### (2) Description of Related Art Including Information Disclosed Under 37 CFR 1.97 and 1.98

The prior art relates describes myriad restraint apparatuses for restraining a body part of an individual. However, the prior art fails to disclose such an apparatus with multiple attachment means which provide versatility in releasing the body part from restraint.

### BRIEF SUMMARY OF THE INVENTION

An embodiment of the disclosure meets the needs presented above by generally comprising a handcuff with a housing, a stationary strand, and a movable strand. The stationary strand is coupled to and extends away from the housing, and the movable strand is pivotably coupled to the stationary strand opposite the housing. The stationary strand and the movable strand are positionable with respect to each other in a closed configuration wherein the stationary strand and the movable strand define a receiving space therebetween. The handcuff further includes a lock, a receiver, a protrusion, and an engagement member. The lock is mounted in the housing and is engageable to the movable strand to secure the stationary strand and the movable strand in the closed configuration. The receiver is releasably couplable to the housing. The receiver defines a cavity in the receiver and an opening to the cavity. The protrusion is coupled to the housing and is insertable into the cavity of the receiver. The engagement member is mounted in the receiver and is operable to engage the protrusion when the protrusion is inserted into the cavity to secure the receiver to the housing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a restraint apparatus according to an embodiment of the disclosure.

FIG. 2 is a front view of an embodiment of the disclosure.

FIG. 3 is a side view of an embodiment of the disclosure.

FIG. 4 is a back view of an embodiment of the disclosure.

FIG. 5 is an in-use view of an embodiment of the disclosure.

### DETAILED DESCRIPTION OF THE INVENTION

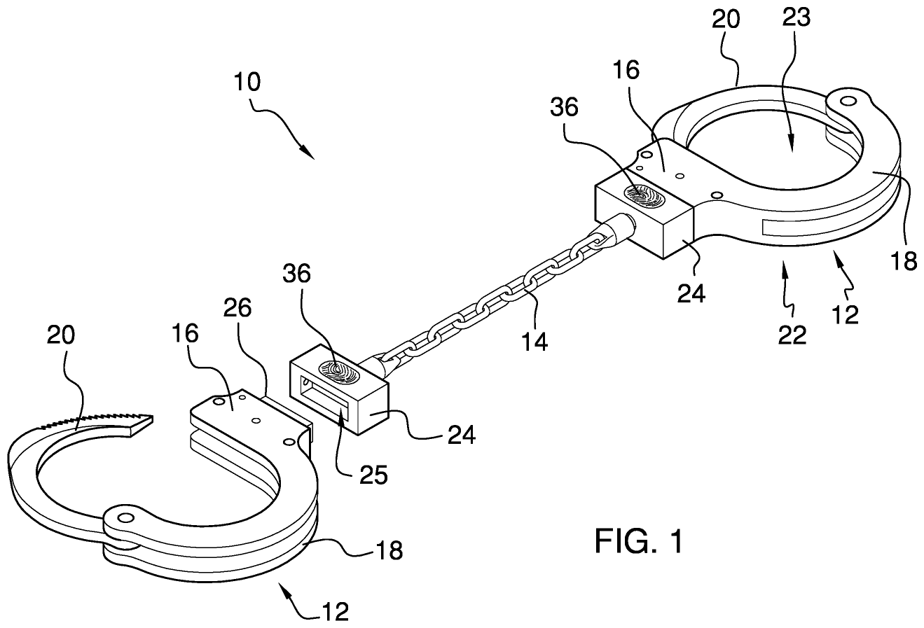

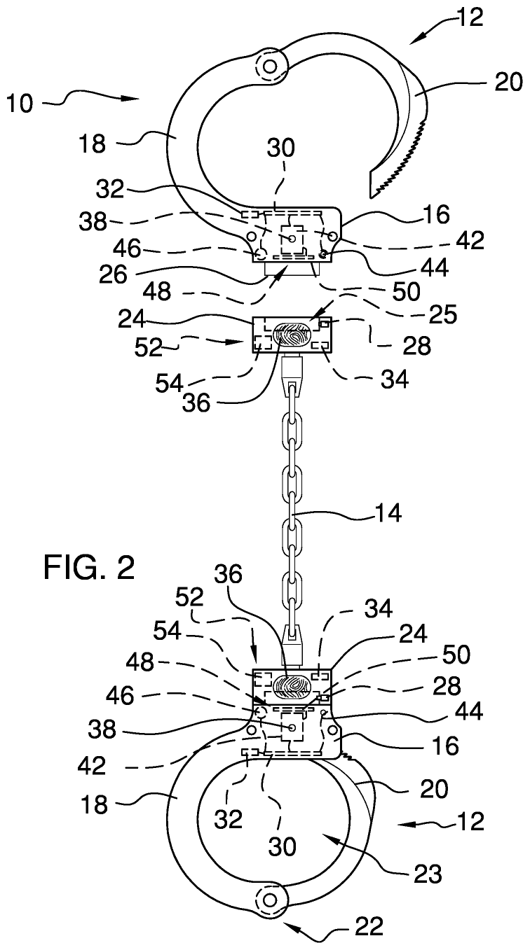

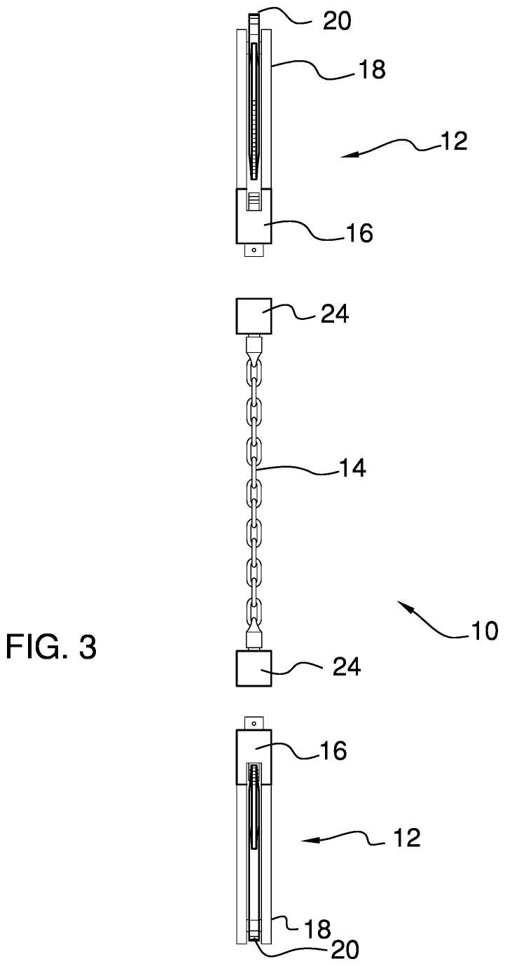

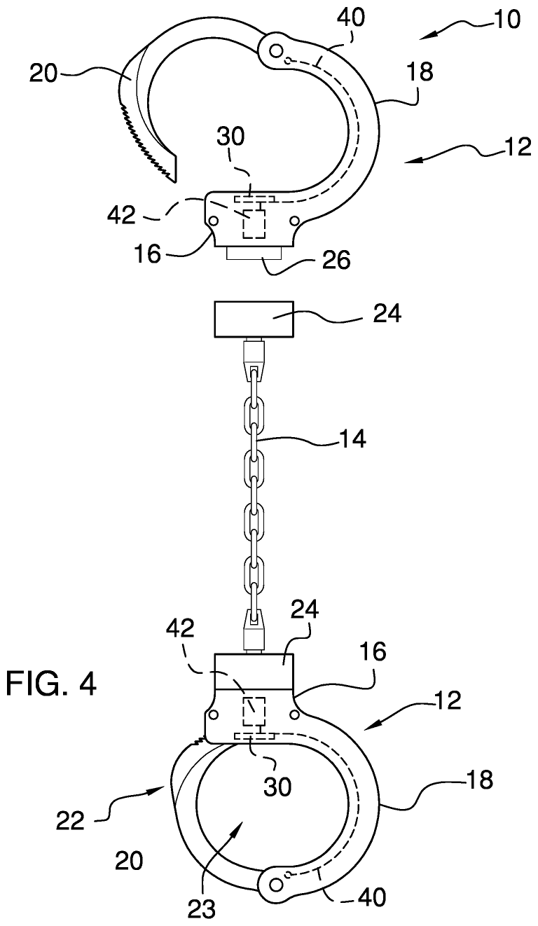

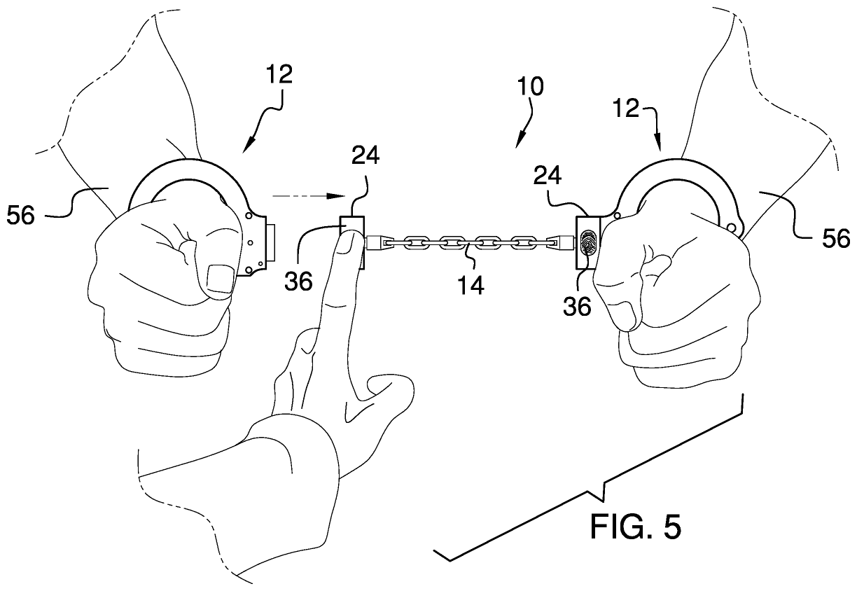

With reference now to the drawings, and in particular to FIGS. 1 through 5 thereof, a new restraint apparatus embodying the principles and concepts of an embodiment of the disclosure and generally designated by the reference numeral 10 will be described.

As best illustrated in FIGS. 1 through 5, the restraint apparatus 10 generally comprises a pair of handcuffs 12 and a tether 14 which is coupled to and extends between the pair of handcuffs 12. The tether 14 comprises a chain but may comprise a cable, a rope, or the like. Each handcuff 12 of the pair of handcuffs 12 comprises a housing 16, a stationary strand 18, and a movable strand 20. The stationary strand 18 is coupled to and extends away from the housing 16. The movable strand 20 is pivotably coupled to the stationary strand 18 opposite the housing 16. The stationary strand 18 and the movable strand 20 are positionable with respect to each other in a closed configuration 22 wherein the stationary strand 18 and the movable strand 20 define a receiving space 23 therebetween. A lock 38 which is mounted in the housing 16 and is engageable to the movable strand 20 to secure the stationary strand 18 and the movable strand 20 in the closed configuration 22.

Each handcuff 12 further comprises a receiver 24, a protrusion 26, and an engagement member 28. The receiver 24 is releasably couplable to the housing 16 and defines a cavity 25 in the receiver 24 and an opening to the cavity 25. The protrusion 26 is coupled to the housing 16 and is insertable into the cavity 25 of the receiver 24. The engagement member 28 is mounted in the receiver 24. The engagement member 28 is operable to engage the protrusion 26 when the protrusion 26 is inserted into the cavity 25 to secure the receiver 24 to the housing 16. The engagement member 28 comprises a securement pin and an actuator. The actuator may be a servomotor, a solenoid actuator, or the like.

Each handcuff 12 also has a processor 30 and a housing transceiver 32. The processor 30 is mounted in the housing 16. The housing transceiver 32 is mounted in the housing 16 and is operatively coupled to the processor 30. The processor 30 is configured to wirelessly communicate to a remote electronic device via the housing transceiver 32.

Each handcuff 12 further includes a receiver transceiver 34 and a fingerprint reader 36. The receiver transceiver 34 is mounted in the receiver 24, and the fingerprint reader 36 is mounted to an exterior of the receiver 24. The fingerprint reader 36 is operatively coupled to the engagement member 28 and is configured to cause the engagement member 28 to release from the protrusion 26 when sensing an authorized finger. The fingerprint reader 36 is also configured to cause the lock 38 to release from the movable strand 20 using a signal sent through the receiver transceiver 34 and the housing transceiver 32 when the fingerprint reader 36 senses the authorized finger. In some embodiments, the fingerprint reader 36 may be programmable to select which of the lock 38 and the engagement member 28 the fingerprint reader 36 causes to release.

Each handcuff 12 includes an electric shock element 40 and a tamper sensor 42. The electric shock element 40 is operatively coupled to the processor 30 and is configured to selectively transmit an electric shock to a body part 56 contained in the receiving space 23. The tamper sensor 42 is coupled to the lock 38 and operatively coupled to the processor 30. The tamper sensor 42 is configured to detect motions indicative of tampering with the lock 38. The tamper sensor 42 may, for example, determine whether an object inserted into the lock 38 has a shape consistent with a key designed to operate the lock 38. The tamper sensor 42 may include a camera, laser scanner, electromechanical sensor, or the like to determine whether the inserted object has the correct shape. The processor 30 is programmed to cause the electric shock element 40 to activate when the tamper sensor 42 detects motions indicative of tampering with the lock 38, thereby shocking the body part 56 contained in the receiving space 23.

Each handcuff 12 further comprises a microphone 44 and a global positioning system 46. The microphone 44 is mounted to the housing 16 and is operatively coupled to the processor 30 such that the processor 30 is configured to receive audible commands via the microphone 44. Audible commands may direct the processor 30 to, for example, alternately secure and release the lock 38 or the engagement member 28. The global positioning system 46 module is mounted in the housing 16 and is operatively coupled to the processor 30 wherein the processor 30 is configured to determine a location of the housing 16. The processor 30 is configured to selectively transmit the location of the housing 16 to the remote electronic device. In some embodiments, commands to the processor 30 may also be made via the remote electronic device, such as operating the lock 38, the engagement member 28, or the electric shock element 40.

Each handcuff 12 has a housing power supply 48 and a receiver power supply 52. The housing power supply 48 is electrically coupled to the processor 30 and comprises a housing battery 50. The receiver power supply 52 is electrically coupled to the engagement member 28, the receiver transceiver 34, and the fingerprint reader 36, and the receiver power supply 52 comprises a receiver battery 54. An additional processor 30 may be housed in the receiver 24 for operating the engagement member 28, the receiver transceiver 34, and the fingerprint reader 36. The additional processor 30 may be electrically coupled to the receiver power supply 52. In some embodiments, a single handcuff 12 is used, which may have further attachment means to attach the handcuff 12 to a structure. Or, in such embodiments, the receiver 24 of the single handcuff 12 may be attached to another structure.

In use, the movable strand 20 and the stationary strand 18 of each handcuff 12 are positioned in the closed configuration 22 around the body part 56, which may be, for example, a wrist, an ankle, or the like. The body part 56 is retained by the restraint apparatus 10, which may additionally be attached or interlocked to another structure. When the tamper sensor 42 detects tampering with the lock 38, the electric shock element 40 delivers an electric shock to the body part 56. The lock 38 may be released via the key. The lock 38 and the engagement member 28 may be released via actuation of the fingerprint reader 36 depending on the embodiment. In some embodiments, the engagement member 28 may also be released via operation of the lock 38 and a resultant signal sent via the housing transceiver 32 and the receiver transceiver 34.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A restraint apparatus comprising a handcuff, the handcuff comprising:
a housing;
a stationary strand being coupled to and extending away from the housing;
a movable strand, the movable strand being pivotably coupled to the stationary strand opposite the housing, the stationary strand and the movable strand being positionable with respect to each other in a closed configuration wherein the stationary strand and the movable strand define a receiving space therebetween;
a lock being mounted in the housing and being engageable to the movable strand to secure the stationary strand and the movable strand in the closed configuration;
a receiver being releasably couplable to the housing, the receiver defining a cavity in the receiver and an opening to the cavity;
a protrusion being coupled to the housing, the protrusion being insertable into the cavity of the receiver, the protrusion being complementary in size and shape to the cavity; and
an engagement member being mounted in the receiver, the engagement member being operable to engage the protrusion when the protrusion is inserted into the cavity to secure the receiver to the housing.

2. The restraint apparatus of claim 1, wherein the handcuff further comprises a fingerprint reader being mounted to the receiver, the fingerprint reader being operatively coupled to the engagement member, the fingerprint reader being configured to cause the engagement member to release from the protrusion when sensing an authorized finger.

3. The restraint apparatus of claim 2, wherein the handcuff further comprises:
a processor being mounted in the housing;
a housing transceiver being mounted in the housing and being operatively coupled to the processor; and
a receiver transceiver being mounted in the receiver;
wherein the fingerprint reader is configured to cause the lock to release from the movable strand when sensing the authorized finger.

4. The restraint apparatus of claim 1, wherein the handcuff further comprises:
a processor being mounted in the housing;
an electric shock element being operatively coupled to the processor, the electric shock element being configured to selectively transmit an electric shock to a body part contained in the receiving space; and
a tamper sensor being coupled to the lock and operatively coupled to the processor, the tamper sensor being configured to detect motions indicative of tampering with the lock, the processor being programmed to cause the electric shock element to activate when the tamper sensor detects motions indicative of tampering with the lock.

5. The restraint apparatus of claim 1, wherein the handcuff further comprises:
a processor being mounted in the housing; and
a microphone being mounted to the housing and being operatively coupled to the processor wherein the processor being configured to receive audible commands via the microphone.

6. The restraint apparatus of claim 1, wherein the handcuff further comprises:
a processor being mounted in the housing; and
a housing transceiver being mounted in the housing and being operatively coupled to the processor, the processor being configured to wirelessly communicate to a remote electronic device via the housing transceiver; and
a global positioning system module being mounted in the housing and being operatively coupled to the processor wherein the processor is configured to determine a location of the housing, the processor being configured to selectively transmit the location of the housing to the remote electronic device.

7. A restraint apparatus comprising:
a pair of handcuffs, each handcuff of the pair of handcuffs comprising:
a housing;
a stationary strand being coupled to and extending away from the housing;
a movable strand, the movable strand being pivotably coupled to the stationary strand opposite the housing, the stationary strand and the movable strand being positionable with respect to each other in a closed configuration wherein the stationary strand and the movable strand define a receiving space therebetween;
a lock being mounted in the housing and being engageable to the movable strand to secure the stationary strand and the movable strand in the closed configuration;
a receiver being releasably couplable to the housing, the receiver defining a cavity in the receiver and an opening to the cavity;
a protrusion being coupled to the housing, the protrusion being insertable into the cavity of the receiver, the protrusion being complementary in size and shape to the cavity;
an engagement member being mounted in the receiver, the engagement member being operable to engage the protrusion when the protrusion is inserted into the cavity to secure the receiver to the housing, the engagement member comprising a securement pin and an actuator;
a processor being mounted in the housing;
a housing transceiver being mounted in the housing and being operatively coupled to the processor, the processor being configured to wirelessly communicate to a remote electronic device via the housing transceiver;
a receiver transceiver being mounted in the receiver;
a fingerprint reader being mounted to the receiver, the fingerprint reader being operatively coupled to the engagement member, the fingerprint reader being configured to cause the engagement member to release from the protrusion when sensing an authorized finger, the fingerprint reader being configured to cause the lock to release from the movable strand when sensing the authorized finger;
an electric shock element being operatively coupled to the processor, the electric shock element being configured to selectively transmit an electric shock to a body part contained in the receiving space;
a tamper sensor being coupled to the lock and operatively coupled to the processor, the tamper sensor being configured to detect motions indicative of tampering with the lock, the processor being programmed to cause the electric shock element to activate when the tamper sensor detects motions indicative of tampering with the lock;
a microphone being mounted to the housing and being operatively coupled to the processor wherein the processor being configured to receive audible commands via the microphone;
a global positioning system module being mounted in the housing and being operatively coupled to the processor wherein the processor is configured to determine a location of the housing, the processor being configured to selectively transmit the location of the housing to the remote electronic device;
a housing power supply being electrically coupled to the processor, the housing power supply comprising a housing battery; and
a receiver power supply being electrically coupled to the engagement member, the receiver transceiver, and the fingerprint reader, the receiver power supply comprising a receiver battery; and
a tether being coupled to and extending between the pair of handcuffs, the tether being mounted to said receiver of each handcuff of the pair of handcuffs, the tether comprising a chain.
